(19) United States
(12) Patent Application Publication
(10) Pub. No.: US 2003/0065490 A1
(43) Pub. Date: Apr. 3, 2003

(54) System and technique for interrogation of an object

(76) Inventor: David F. Lowry, West Richland, WA (US)

Correspondence Address: John M. Bradshaw, Woodard, Emhardt, Naughton, Moriarty and McNett, Bank One Center/Tower, Suite 3700, 111 Monument Circle, Indianapolis, IN, 46204-5137, US

(21) Appl. No.: 09/964,938

(22) Filed: Sep. 27, 2001

(51) Int. Cl. G06F 7/60; G06F 17/10

(52) U.S. Cl. 703/2

(57) ABSTRACT

A technique for multidimensional NMR data collection is presented. The possible correlations in a proposed multi-dimensional experiment are inferred from the correlations found in a pair of high-resolution multi-dimensional faces of the multi-dimensional experiment. The possible correlations are then rejected or accepted based on a least squares fit to a severely truncated multi-dimensional experiment. The pair of high resolution faces used to develop the possible correlations are of a dimension one less than the translated multi-dimensional experiment. The technique is particularly useful on small heteronuclear labeled proteins.

### GOVERNMENT RIGHTS

This invention was made with Government support under Contract Number DE-AC0676RLO1830 awarded by the U.S. Department of Energy. The Government has certain rights in the invention.

### BACKGROUND OF THE INVENTION

Multi-dimensional spectroscopic techniques have many applications, but their usefulness is often limited by long data acquisition periods. For instance, biological structure determination can be made by nuclear magnetic resonance (NMR) analysis, but a high throughput technique is currently prohibited by the long time periods that are needed to collect the NMR data. For example, protein structure determination by NMR might require acquisition of eight or more sets of multi-dimensional time-series data where the length of time needed to acquire a single time series with conventional techniques can be two to three days or even longer.

A contributing factor to the length of time is that only one dimension of the time-series is acquired in real-time. As an illustration, a two-dimensional (2D) time-series can be considered a series of one-dimensional real-time signals that are generated as a function of a discrete delay time, incremented for each real-time signal. The dimensions of a time-series that are acquired discretely are termed indirect dimensions. A 2D time-series with n increments in the indirect dimension is normally acquired in time nτ, where τ is the time it takes to acquire a single 1D real-time signal. An N-dimensional (ND) time series, with n increments in each of the N−1 indirect dimensions would consist of n^{N-1} time points and would be acquired in time n^{N-1}τ. Therefore, the data acquisition time generally increases as the N−1 power of n, providing a bottleneck to rapid data acquisition.

One approach to reducing the data acquisition time is to intentionally truncate one or more indirect dimensions of the time series to v increments. The truncated data must then be transformed with special processing routines, such as linear prediction or maximum entropy reconstruction, to maintain resolution and avoid the introduction of truncation artifacts in the resulting spectrum. However, even with these techniques the data acquisition time is still proportional to v^{N-1}.

Therefore, a need exists for improved systems and techniques for the acquisition of multi-dimensional spectroscopic data.

### SUMMARY OF THE INVENTION

In one embodiment of the invention there is provided a novel technique for acquiring multi-dimensional spectroscopic information. The technique includes forming a model of multi-dimensional spectroscopic information including at least one set of two or more mutually exclusive terms, where the set of terms are formed from first and second spectroscopic data sets of a dimension less than the modeled multi-dimensional information, and selecting one of the set of mutually exclusive terms to represent the multi-dimensional spectroscopic information. In one refinement the term is selected by fitting the model to a third spectroscopic data set. In the above or in other refinements, the third data set is obtained at substantially lower resolution than the first or second data sets. In the above or in still other refinements, the terms represent a correlation of features of the first and second data sets, where in still further refinements, the features represent peak frequencies and associated decay rates.

In another embodiment, a novel technique includes providing a series of stimuli to an object at varying times and determining the response of the object to the series of stimuli to obtain first and second multi-dimensional interrogation data sets, forming a model of multi-dimensional information of a dimension higher than the dimension of the first or second data sets, the model including at least one set of terms where each term in the set represents a potential correlation between features of the first and second data sets, and determining which term in the set represents the actual correlation between features of the first and second data sets by comparing the model to a third multi-dimensional data set.

A further embodiment provides a method for determining multi-dimensional information concerning an object by forming first and second multi-dimensional data sets representing projections of information of a dimension one higher than the dimension of the first and second data sets; correlating the first and second data sets to form a model of the multidimensional information, the model including a set of terms where each term in the set represents a potential correlation between features in the first and second data sets; determining which of the terms represents the actual correlation of features in the first and second data sets by comparing the model to a third multi-dimensional data set representing information concerning the object.

In still further embodiments, systems capable of carrying out at least a portion of the inventive methods are provided. One such inventive system includes a device carrying logic to form a model of multi-dimensional information wherein the model includes at least one set of terms where each term represents a potential correlation between features in at least first and second multi-dimensional data sets of a dimension less than the modeled information, and to select one of the set of terms for representing the multi-dimensional information by comparing the model to a third multi-dimensional data set.

### BRIEF DESCRIPTION OF THE DRAWINGS

FIG. 1 is a flow chart of a method according to an embodiment of the present invention.

FIG. 2 is a schematic illustration of a system of the present invention.

FIG. 3 is a representative pair of correlated 2D plots of NMR spectra of a common sample.

### DESCRIPTION OF PREFERRED EMBODIMENTS

For the purposes of promoting an understanding of the principles of the invention reference will now be made to the embodiments illustrated in the drawings and specific language will be used to describe the same. It will nevertheless be understood that no limitation of the scope of the invention is thereby intended. Any alterations and further modifications in the illustrated embodiments, and any further applications of the principles of the invention as illustrated herein being contemplated as would normally occur to one skilled in the art to which the invention relates.

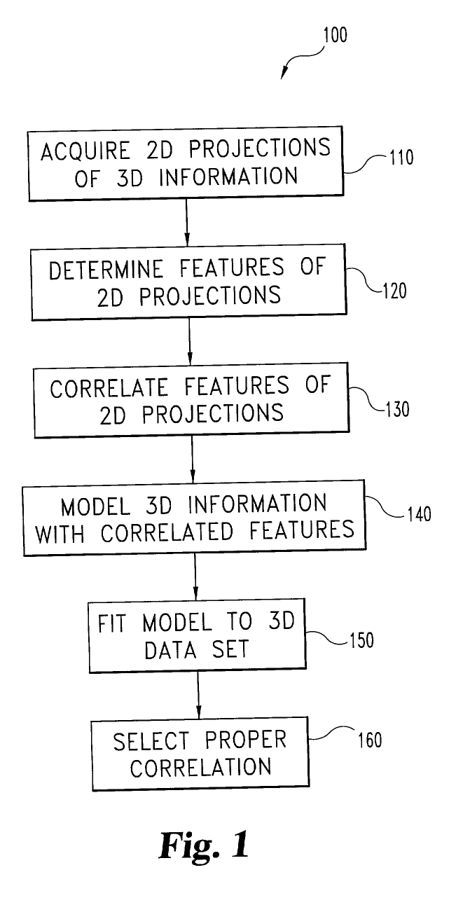

Turning now to FIG. 1, a flowchart of process 100 is depicted. Process 100 is useful in determining three dimensional (3D) spectroscopic information and in the embodiment that follows, is used to determine 3D NMR data. Thus 3D NMR data is the desired information and, as describe below, process 100 involves the use of a pair of 2D projections and a third NMR data set to determine the desired information. An advantage of process 100 is that this third NMR data set can be a severely truncated data set, without significantly compromising the integrity of the determined 3D NMR data. In process 100, a model is formed from the pair of 2D data projections and fit to the third, potentially severly truncated, NMR data set. After fitting the model to the third NMR data set, the model can be used to represent the NMR information.

Process 100 begins with action 110 which calls for the provision of two dimensional (2D) projections of the desired 3D information. These projections are also conventionally termed faces of a 3D NMR experiment. These projections are obtained by performing a 2D NMR experiment in the selected dimensions or by reference to a previously performed experiment. Optionally, theoretical formulations for the 2D faces could be utilized.

Following action 110, action 120 calls for an analysis of the obtained 2D projections to determine significant features of the projections. In an NMR data set, these features relate to the spectral peaks and include the peak frequencies and linewidths of those peaks in the 2D projections. These features are acquired through data analysis of the 2D projections with a lineshape fitting routine useful for extracting peak frequencies and linewidths. Any of various peak picking routines can be used for this purpose, including for example, the Felix 2D Module software by Accelrys, Inc. of 300 Lanidex Plaza, Parsippany, N.J. 07054.

Once determined, the features of the 2D projections are correlated by matching feature pairs in action 130. The preferred method to correlate features is to match a common coordinate value of the various features along a common axis of the 2D projections. The match can be exact or merely determined within a predetermined error range, which range can be selected based on the NMR machine resolution. For many NMR applications, this common coordinate can be the proton frequency. Once a feature belonging to a common coordinate (or coordinate range) is identified, it is correlated with all other features from each of the 2D projections at that common coordinate (or coordinate range).

In many cases, a pair of features in each of the 2D projections will be relatively isolated, meaning there are not other features in the 2D projections at a similar common coordinate or location in each of the 2D projections. These relatively isolated feature pairs can be readily correlated with each other and will not also be correlated with other features.

In other cases, more than one feature of a 2D projection can be correlated with one or more other features in another 2D projection. This can occur by multiple features residing at the same or similar coordinate or location in the 2D projections. These latter features are degenerate and are correlated multiple times in action 130, forming a correlated feature set of all possible correlations of the degenerate features. However, while there may be multiple correlations for a single feature of a 2D projection, these are merely potential correlations. Typically, only one of the correlations will be the actual physical correlations of that feature.

The correlated features are then used to form a model of 3D spectroscopic information in action 140. A purpose of this model is to resolve which of the potential correlations of degenerate features is the actual physical correlation. In a preferred form, the model is a linear combination of terms representing the potential correlations of features multiplied by a weighting factor. Using the proton frequency as the common axis and the two indirect dimensions of the two 2D faces being the nitrogen and carbon frequencies, the model is:

$$F ( {τ}_{N} , {τ}_{C} ; {ω}_{H} ) = {\sum }_{k , l}^{K , L} {a}_{kl} {f}_{kl} ( {τ}_{N} , {τ}_{C} ; {ω}_{H} ) \qquad [ 1 ]$$

where F(τ_{N},τ_{C};ω_{H}) is the 2D indirect dimension time series data at time τ_{N} in the nitrogen dimension and time τ_{C} in the carbon dimension at proton frequency ω_{H}; K, L are the total number of degenerate resonances in the HN and HC faces respectively; k,l are indices for these degenerate resonances; and fₖₗ are the terms representing the potential correlations of the features in the 2D projections. In other words, fₖₗ are the possible synthetic time dependences of F constructed from the frequencies and decays (ωₖ^{N}, rₖ^{N}), (ωₗ^{C}, rₗ^{C}) present in the projections:

fₖₗ(τ_{N},τ_{C};ω_{H})=exp(−rₖ^{N}τ_{N})exp(iωₖ^{N}τ_{N})exp(−rₗ^{C}τ_{C})exp(jωₗ^{C}τ_{C}). [2]

The aₖₗ are the amplitudes that connect ωₖ^{N} with ωₗ^{C}; and i and j are √−1 in each of the two dimensions of the hypercomplex vector f.

Having formed a model of 3D data, the model is fit to actual 3D data in action 150. A least squares fit is used to fit the model to 3D data with the amplitudes or weighting factors, aₖₗ, being the variables used in finding the best fit with a set of 3D time series data. Once the fit is performed, a high value for aₖₗ indicates an actual correlation between ωₗ^{C} and ωₖ^{N}, whereas a low value for aₖₗ will imply that no such correlation actually exists. The value of the aₖₗ's is then used in action 160 to select the proper actual correlations between features in the 2D projections. Usefully, the values of the aₖₗ's can be compared to a threshold value, with aₖₗ's exceeding the threshold indicating actual correlation and aₖₗ's below the threshold indicating absence of actual correlation.

A preferred fitting technique is the Gauss linear least-squares method which is used to minimize a maximum likelihood estimator, or cost function. The cost function is the sum over indirect sampling times of the squares of the difference between the actual 3D time series data and the modeled data:

$$min \{ {\sum }_{{τ}_{N} , {τ}_{C }} {\vert F ( {τ}_{N} , {τ}_{C} ; {ω}_{H} ) - {\sum }_{k , l} {a}_{kl} {f}_{kl} ( {τ}_{N} , {τ}_{C} ; {ω}_{H} ) \vert}^{2} \} . \qquad [ 3 ]$$

The minimum of this cost function occurs when all partial derivatives of the function with respect to the aₖₗ are equal to 0:

$$\frac{\partial }{\partial {a}_{{k}^{′} {l}^{′}}} \{ {\sum }_{{τ}_{N} , {τ}_{C }} {\vert F ( {τ}_{N} , {τ}_{C} ; {ω}_{H} ) - {\sum }_{k , l} {a}_{kl} {f}_{kl} ( {τ}_{N} , {τ}_{C} ; {ω}_{H} ) \vert}^{2} \} = 0 ; ∀ {k}^{′} , {l}^{′} . \qquad [ 4 ]$$

Equivalently:

$$\text{<} {f}_{{k}^{′} {l}^{′}} \cdot F \text{>} = {\sum }_{k , l} {a}_{kl} \text{<} {f}_{{k}^{′} {l}^{′}} \cdot {f}_{kl } \text{>} ; ∀ {k}^{′} , {l}^{′} , \qquad [ 5 ]$$

where the brackets indicate a sum over all time points and the indicates a dot product.

Having determined the actual correlations of features in the 2D faces, a model of the 3D information is formed as a linear combination of the terms fₖₗ representing only the actual correlations. Equivalently, equation (1) is used to represent the 3D information with aₖₗ from the fit equal to the intensity of the actual correlations and aₖₗ equal to the noise intensity for all other correlations.

The determined 3D information can then be used in a variety of applications in an equivalent manner as would 3D information determined directly from a 3D spectroscopic experiment. One example includes use to determine the structure of protein samples, such as a heteronuclear labeled proteins. Other potential interrogation targets include NMR studies of biomolecular dynamics or drug design. As another example, inventive methods can find use as a part of analyzing genes.

It is to be understood that, in typical applications of the present invention, NMR experiments will be performed to obtain both the 2D projections and the 3D data set to which the model containing the potential correlations of features is fit. The experiments for the 2D projections are preferably performed at high resolution, meaning data is obtained at multiple indirect time steps at small increments to each other, so as to provide a large data set able to provide accurate peak resolution. The 3D experiment, by contrast, is performed at substantially lower resolution, or smaller number of indirect time steps, since the result of the 3D experiment is not intended to be solely used to represent the desired 3D information. Rather, information extracted from the higher resolution 2D experiments is used to form the desired 3D information, without needing a 3D NMR experiment to directly observe all of the desired information. In other words, by using the technique described herein, the 3D experiment is able to be performed at a resolution substantially lower than would be needed if the 3D experiment alone were to provide the desired 3D information.

While described above with respect to the determination of 3D information using 2D projections or faces, it is to be understood that the inventive method can be used in determining information of even higher dimension. For example a pair of 3D data sets having two common dimensions can be used to formulate potential correlations for 4D information. Any degenerate potential correlations are then resolved by fitting a model containing the potential correlations to a 4D data set. It is also to be understood that the 3D data sets used to make the 4D potential correlation could themselves be determined from pairs of 2D data sets according to the techniques described herein. Additionally, the 4D potential correlation could be determined from 3 2D data sets.

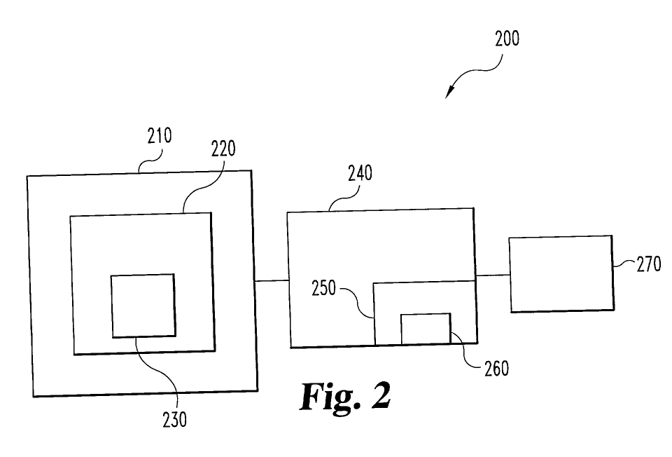

Turning now to FIG. 2, a system useful for practicing the present invention is depicted. System 200 includes a machine 210 having an interrogation chamber 220 into which a sample 230 is placed. Machine 210 is operable to perform multi-dimensional spectroscopic interrogation of sample 230. In the illustrated embodiment, machine 210 can be a conventional multi-dimensional NMR machine.

Workstation 240 is coupled to machine 210 to control operation of machine 210 and to receive data from machine 210. The various hardware and software components that implement the methods of the present invention are combined in workstation 240. Monitor 260 provides visual output from workstation 250 to an operator. Workstation 240 may include more than one processor or CPU and more than one type of memory 250, where memory 250 is representative of one or more types. Furthermore, it should be understood that while one workstation 240 is illustrated, more workstations may be utilized in alternative embodiments. Workstation 240 contains a processor that may be comprised of one or more components configured as a single unit. Alternatively, when of a multi-component form, the processor may have one or more components located remotely relative to the others. One or more components of the processor may be of the electronic variety defining digital circuitry, analog circuitry, or both. In one embodiment, the processor is of a conventional, integrated circuit microprocessor arrangement, such as one or more PENTIUM II or PENTIUM III processors supplied by INTEL Corporation of 2200 Mission College Boulevard, Santa Clara, Calif., 95052, USA. Software programs and modules embodying the methods described above are encoded on a hard disc for execution by the processor.

Memory 250, including removable portion 260, may include one or more types of solid-state electronic memory, magnetic memory, or optical memory, just to name a few. By way of non-limiting example, memory 250 may include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, memory 250 may be volatile, nonvolatile, or a hybrid combination of volatile and nonvolatile varieties.

As is known in the art, machine 210 is operable to deliver a series of pulses to sample 230 and record the response of sample 230 to the pulses while subjecting sample 230 to a uniform magnetic field. Machine 210 is also conventionally operable to obtain multi-dimensional data sets by varying the time between pulses in a series. Machine 210 or workstation 240, also contains logic operable to analyze the response of the sample to the series of pulses and determine spectroscopic information therefrom.

It will be understood by those of skill in the art that there is described herein systems and technique that allows the acquisition of an ND correlation in a time that is proportional to nN. Systems and techniques are also described that are operable to rapidly and cost effectively obtain NMR spectra and in particular protein NMR spectra. Systems and techniques are also described where NMR data need not be acquired with linear sampling and sampling schedules can be tailored to match the signal envelope and maximize signal-to-noise (S/N) ratio for a given number of time points.

Having described preferred systems and techniques operable to carryout the principles of the present invention, an example of the inventive technique is now presented.

### EXAMPLE

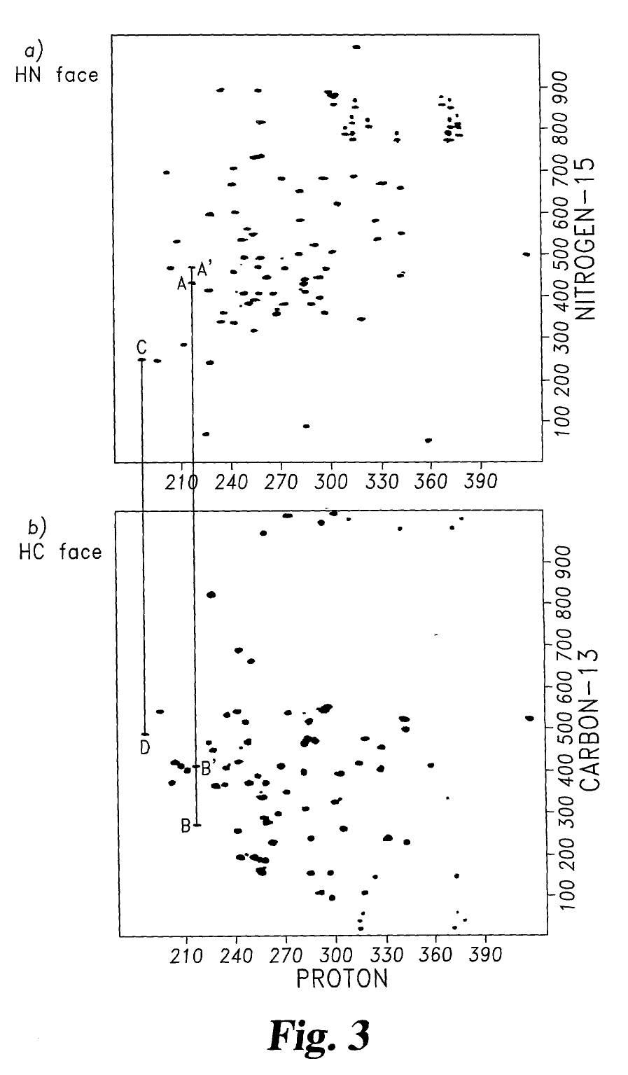

The method describe above with respect to FIG. 1 was performed on data obtained for a 3D HNCO NMR analysis of a 1 mM [¹⁵N, ¹³C]-labeled ubiquitin sample at 25° C. Data was collected on an 800 MHz spectrometer, the Varian 800-Inova spectrometer (Varian, Incorporated, 3120 Hansen Way, Palo Alto, Calif. 94304) equipped with a triple-resonance ¹H/¹³C/¹⁵N probe and a gradient amplifier. The 2D faces for this sample are depicted in FIG. 3, where an HN HSQC spectrum is substituted for the HN face because the latter is recorded as a constant-time experiment which limits resolution.

One observes that along any particular proton coordinate in the HN face, there are not many nitrogen resonances correlated with that proton coordinate. Many of the proton-nitrogen peaks, such as peak C in the HN face, are isolated and correlated with isolated peaks in the HC face. For example peak C in the HN face is correlated with peak D in the HC face. Thus, these isolated peaks can be readily paired with each other without a 3D data set. The remaining peaks, for this sample and field strength, happen to have a degeneracy no greater than two. For instance, degenerate peaks A and A′ in the HN face are each potentially correlated with peaks B and B′ in the HC face. Thus there are four possibilities for the frequencies and decay rates corresponding to these peaks that could be present in the 3D data.

The present method was performed on all degenerate peaks in the spectrum in FIG. 3. The model formed according to equations (1) and (2) based on the data in FIG. 3 was fit to 7 indirect time points taken from a full 3D experiment. Sampling schedules for the 3D time points were chosen to match signal envelopes in order to maximize the signal to noise ration (S/N). Because the 3D experiment is constant-time in the nitrogen dimension but not the carbon dimension, the nitrogen time points were generated with a random number generator while the carbon times were exponential. The indirect time data points used were as follows: (nitrogen, carbon) {(55, 1), (19, 2), (12, 4), (38, 8), (63, 16), (5, 32), (38, 64)}. The 3D data corresponding to these indirect time points was used to calculate the least-squares coefficients for the 11 degenerate peak pairs. All peaks were correctly correlated by the 7 point fit, as was verified by comparison of the determined correlations with the actual 3D data obtained by a full 3D experiment on the sample. Table 1 illustrates the correlation amplitude and the intensity of the actual 3D data for the possible correleations for peaks A and A′ with peaks B and B′.

TABLE 1
Correlation amplitudes versus 3D Data Intensities

| Possible a-priori | Correlation | Intensity |
|---|---|---|
| Correlation | Amplitude | of 3D Data |
| A, B | 376 | 21 |
| A, B’ | 3047 | 3224 |
| A’, B | 2822 | 3532 |
| A’, B’ | −313 | −54 |

As can be seen, peaks A, B′ and A′, B are correlated with a signal to noise ratio of nearly 10:1.

The NMR experiments were generated from Protein-Pack software with 512 increments in indirect dimensions of the 2D experiments and 64 increments in both indirect dimensions of the 3D experiment. The 2D experiments were each acquired in 11 hours with 32 scans, although it is believed that 1 hour experiments would have sufficed for this sample. The full 3D HNCO experiment with 4096 (64×64) indirect points was acquired in 42.25 hours with 8 scans. Thus, to obtain only the 7 points used in the least squares fit would have taken only 5 minutes.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding. All publications, patents, and patent applications cited in this specification are herein incorporated by reference as if each were specifically and individually indicated to be incorporated by reference and set forth in its entirety herein, including without limitation the following:

1. Bax, A.; Grzesiek, S. Acc. Chem. Res 26, 131 (1993).

2. Zhu, G.; Bax, A. J. Magn. Reson. 90, 405 (1990).

3. Hoch, J. C.; Stem A. S. NMR Data Processing; Wiley-Liss, New York, pp 77-135 (1996).

4. Manassen, Y.; Navon, G.; Moonen, C. T. W. J. Magn. Reson 72, 551 (1987).

5. Manassen, Y.; Navon, G. J. Magn. Reson. 79, 291 (1988).

6. McGeorge G.; Hu J. Z.; Mayne C. L.; Alderman D. W.; Pugmire R. J.; Grant D. M. J. Magn. Reson. 129, 134 (1997).

7. Grzesiek S.; Bax, A. J. Magn. Reson. 96, 432 (1992).

8. Press, W. H.; Teukolsky, S. A.; Vetterling, W. T.; Flannery, B. P. Numerical Recipes in C, 2^{nd} ed.; Cambridge University Press, New York, pp 32-102, 656-671 (1992).

What is claimed is:

1. A method comprising:
forming a model of multi-dimensional spectroscopic information including at least one set of two or more mutually exclusive terms, the set of terms formed from at least first and second multi-dimensional spectroscopic data sets of a dimension less than the modeled multi-dimensional information,
selecting only one of the set of mutually exclusive terms to represent the multi-dimensional spectroscopic information by fitting the model to a third multi-dimensional spectroscopic data set.

2. The method of claim 1 wherein the first and second data sets share a common dimension and the second data set has at least one dimension orthogonal to a dimension in the first data set.

3. The method of claim 2 wherein the orthogonal dimensions are frequency dimensions and wherein the set of mutually exclusive terms include frequency and decay rates determined from the first and second data sets.

4. The method of claim 1 further comprising representing the multi-dimensional information with a model including only the selected term of the set of mutually exclusive terms.

5. The method of claim 1 wherein the set of mutually exclusive terms include frequency and decay rates determined from the first and second data sets.

6. The method of claim 5 wherein the first and second data sets are of dimension one less than the third data set.

7. The method of claim 6 wherein the third data set is an NMR spectrum.

8. The method of claim 7 wherein the third data set is a protein NMR spectrum.

9. The method of claim 1 wherein the third data set is obtained at lower resolution than the first and second data sets.

10. The method of claim 1 further comprising:
obtaining peak frequencies and associated decay rates from the first and second data sets, and
forming the set of mutually exclusive terms with the obtained frequencies and associated decay rates.

11. A method of analyzing a physical object comprising:
providing a series of stimuli to the object and determining the response of the object to the series of stimuli,
varying the times between the stimuli in the series to form at least first and second multi-dimensional data sets of the response of the object to the series of stimuli,
forming a model of multi-dimensional information of a dimension higher than the dimension of the first or second data sets, the model including at least one set of terms where each term in the set represents a potential correlation between features of the first and second data sets,
determining which term in the set represents the actual correlation between features of the first and second data sets by comparing the model to a third multi-dimensional data set.

12. The method of claim 11 wherein the features of the first and second data sets include frequency and decay rates.

13. The method of claim 11 further comprising representing the multi-dimensional information with a model including the term determined to be representative of the correlation of features.

14. The method of claim 11 wherein providing the series of stimuli and varying the times between the stimuli include performing a multi-dimensional NMR analysis of the object.

15. The method of claim 11 wherein the formed model includes a plurality of sets of terms, and the method further comprises selecting one from each of the sets of terms to represent the actual correlation of features in the first and second data sets.

16. The method of claim 11 wherein the object is a protein.

17. The method of claim 16 wherein the protein is a heteronuclear labeled protein.

18. A device comprising:
a computer readable media containing programming instructions for a multidimensional interrogation device, the instructions operable to cause the multidimensional interrogation device to:
form a model of multi-dimensional interrogation information including at least one set of terms where each term represents a potential correlation between features of at least first and second multi-dimensional data sets, the first and second data sets of a dimension less than the modeled information, and
determine which term represents the actual correlation between features of the first and second data sets by comparing the model to a third multi-dimensional data set.

19. The device of claim 18 wherein the instructions are operable to cause the interrogation device to fit the model to the third multi-dimensional data set to determine which term represents the actual correlation between features.

20. The device of claim 19 wherein the features of the first and second data sets include peak frequencies and associated decay rates.

21. The device of claim 18 wherein the computer readable media is selected from the group consisting of floppy disks, magnetically encoded hard disks, tapes, cartridges and optical disks.

22. The device of claim 21 wherein the multi-dimensional interrogation device includes a multi-dimensional NMR machine.

23. The device of claim 22 wherein the features of the first and second data sets include peak frequencies and associated decay rates of multi-dimensional NMR data sets.

24. A method comprising:
forming at least one set of terms from at least first and second multi-dimensional spectroscopic data sets wherein each of the terms in the set is representative of potential correlations between features in the first and second data sets,
determining which of the set of terms represents the actual correlation between features of the multi-dimensional data sets by comparing the model to a third multi-dimensional spectroscopic data set,
representing multi-dimensional spectroscopic information with the determined term.

25. The method of claim 24 wherein determining which term represents the actual correlation between features includes fitting the model to the third multi-dimensional data set.

26. The method of claim 24 wherein the features of the first and second multi-dimensional data sets include peak frequencies and associated decay rates.

27. The method of claim 24 wherein the at least first and second multi-dimensional spectroscopic data sets include NMR data sets.

28. The method of claim 27 wherein the NMR data sets are data sets from NMR analysis of biological material.

29. The method of claim 24 wherein the third data set is obtained at lower resolution than the first and second data sets.

30. An apparatus comprising:
a device carrying logic to:
form a model of multi-dimensional information wherein the model includes at least one set of terms where each term represents a potential correlation between features in at least first and second multi-dimensional data sets of a dimension less than the modeled information,
select one of the set of terms for representing the multi-dimensional information by comparing the model to a third multi-dimensional data set.

31. The apparatus of claim 30 wherein the device also carries logic to determine the features in the first and second data sets.

32. The apparatus of claim 30 wherein the device is a computer readable memory device.

33. A method for determining multi-dimensional information concerning an object, comprising:
forming first and second multi-dimensional data sets representing projections of information concerning an object of a dimension one higher than the first and second data sets;
correlating the first and second data sets to form a model of the multidimensional information concerning the object, the model including at least one set of terms where each term in the set represents a potential correlation between features in the first and second data sets;
determining which of the terms represents the actual correlation of features in the first and second data sets by comparing the model to a third multi-dimensional data set representing information concerning the object.

34. The method of claim 33 wherein the third data set is obtained at lower resolution that the first and second data sets.

35. The method of claim 1 wherein fitting the model to a third multi-dimensional data set includes extremizing an error term quantifying the difference between data from the third data set and the modeled multi-dimensional spectroscopic information.

36. The method of claim 35 wherein fitting the model includes performing a linear least squares fit.

37. The method of claim 11 wherein the term representing the actual correlation between features of the first and second data sets is determined by minimizing a term quantifying the difference between data from the third data set and corresponding output of the modeled information.
